(19) United States
(12) Patent Application Publication
(10) Pub. No.: US 2013/0283723 A1
(43) Pub. Date: Oct. 31, 2013

(54) CORNER JOINT WITH CAPILLARY BREAK AND METHOD OF ASSEMBLY

(71) Applicant: Mark Engstrom, Marine on St. Croix, MN (US)

(72) Inventor: Mark Engstrom, Marine on St. Croix, MN (US)

(21) Appl. No.: 13/827,327

(22) Filed: Mar. 14, 2013

Related U.S. Application Data
(60) Provisional application No. 61/639,214, filed on Apr. 27, 2012.

(51) Int. Cl. E06B 3/96

(52) U.S. Cl. CPC E06B 3/96
USPC 52/656.9; 29/428

(57) ABSTRACT

Corner joints and methods of forming such joints using hollow frame members are described. The corner joints are manufactured using corner keys inserted into the ends of the frame members. In addition to holding the frame members together, one or more capillary break members protrude from the corner key so that the one or more capillary break members are located between the assembled frame members and the corner key forming the corner joint.

### RELATED APPLICATION

This application claims the benefit of U.S. Provisional Patent Application No. 61/639,214 titled CORNER JOINT WITH CAPILLARY BREAK AND METHOD OF ASSEMBLY filed on Apr. 27, 2012, which is hereby incorporated by reference in its entirety.

Corner joints with one or more capillary breaks and methods of assembling such joints are described herein.

The structures used to join framing components in a variety of structural units such as, e.g., window sashes, window frames, doors, door frames, picture frames, etc. may take a variety of different forms. In some instances, such as, e.g., window frames or window sashes, corner joints may include a corner key positioned in the hollow ends of frame members.

The frame members meet at the corner joint along joint surfaces, such that the joint surfaces of the frame members face each other when the frame members are assembled with a corner key to form a corner joint. As described herein, adhesive material is typically delivered into the corner joint such that the frame members are secured to the corner key. The flow of the adhesive materials is, however, preferably controlled such that the adhesive material does not flow into the interface between the joint surfaces because the adhesive can, in some instances, adversely affect the appearance of the corner joint if the adhesive material advances out of the interface between the frame members.

### SUMMARY

Corner joints and methods of forming such joints using hollow frame members are described herein. The corner joints are manufactured using corner keys inserted into the ends of the frame members. In addition to holding the frame members together, one or more capillary break members protrude from the corner key so that the one or more capillary break members are located between the assembled frame members and the corner key forming the corner joint.

Capillary break members are provided in the corner joints described herein to address leakage of water from the exterior side of the corner joint to the interior side of the corner joint through interfaces between the joint surfaces. The joint surfaces of the frame members are not, however, directly attached to each other within at least a portion of the interface. As a result, a thin film of water may be present in the exterior portion of the interface.

Capillary action may cause the film of water in the exterior portion of the interface to advance to the interior side of the corner joint. Although capillary action may cause the water to advance along the interface, the same capillary forces may retain the water within the interface such that leakage out of the interior side of the corner joint does not occur. In some conditions, however, such as increased pressure differentials between the exterior and interior sides of the corner joints, water can leave the interface on the interior side of the corner joint, resulting in a leak. The corner keys of the corner joints described herein, however, include one or more capillary break members to interrupt that capillary action.

A potential advantage of providing one or more capillary break members protruding from the corner keys of the corner joints described herein is that proper placement of the capillary break members can be obtained during assembly of the corner keys and the frame members without requiring separate placement of the capillary break members during the assembly process.

As used herein, the terms “exterior” and “interior” refer to the sides of a wall in a building structure in which the structural unit is installed. The term “exterior” refers to the side of the wall that is exposed to precipitation or water from other sources.

In one aspect, the corner joints described herein may include a first frame member comprising a first corner end, wherein the first corner end comprises a first joint surface and a first corner end opening; a second frame member comprising a second corner end, wherein the second corner end comprises a second joint surface and a second corner end opening, wherein the second joint surface faces the first joint surface when the second frame member and the first frame member are assembled to form a corner; a corner key comprising a first leg and a second leg, wherein the first leg is located in the first corner end opening and the second leg is located in the second corner end opening when the first frame member and the second frame member are assembled with the corner key to form the corner joint; and a capillary break member protruding from the corner key, wherein the capillary break member is located between the first joint surface and the second joint surface when the first frame member and the second frame member are assembled with the corner key to form the corner joint.

In one or more embodiments of the corner joints described herein, the capillary break member comprises a continuous body extending completely across an interface between the first joint surface and the second joint surface.

In one or more embodiments of the corner joints described herein, the first frame member and the second frame member form a glazing channel when assembled to form the corner joint, and wherein the capillary break member comprises a continuous body extending across completely across an interface between the first joint surface and the second joint surface on a side of the glazing channel. In one or more embodiments, the capillary break member extends into the glazing channel.

In one or more embodiments of the corner joints described herein, a portion of the capillary break member extends into a glazing channel formed by the first frame member and the second frame member as assembled to form the corner joint.

In one or more embodiments of the corner joints described herein, the capillary break member is located in the interface between the first joint surface and the second joint surface along the an outside edge of the corner joint when the corner joint is assembled. In one or more embodiments, the capillary break member comprises a continuous body extending across completely across the interface between the first joint surface and the second joint surface at the outside edge of the corner joint. In one or more embodiments, the capillary break member protrudes from the outside edge of the corner joint.

In one or more embodiments of the corner joints described herein, the first joint surface is not directly attached to the second joint surface within the corner joint.

In one or more embodiments of the corner joints described herein, the capillary break member comprises a compressible member.

In one or more embodiments of the corner joints described herein, the capillary break member comprises a resiliently compressible member.

In one or more embodiments of the corner joints described herein, the capillary break member is insert molded with the corner key.

In one or more embodiments of the corner joints described herein, a portion of the capillary break member is located in an opening in the corner key. In one or more embodiments, the opening comprises a slot that comprises an external opening located along an edge of the corner key.

In another aspect, the corner joints described herein may include a first frame member comprising a first corner end, wherein the first corner end comprises a first joint surface and a first corner end opening; a second frame member comprising a second corner end, wherein the second corner end comprises a second joint surface and a second corner end opening, wherein the second joint surface faces the first joint surface when the second frame member and the first frame member are assembled to form a corner; a corner key comprising a first leg and a second leg, wherein the first leg is located in the first corner end opening and the second leg is located in the second corner end opening when the first frame member and the second frame member are assembled with the corner key to form the corner joint; a first capillary break member protruding from the corner key, wherein the first capillary break member is positioned between the first joint surface and the second joint surface at a first location when the first frame member and the second frame member are assembled with the corner key to form the corner joint; and a second capillary break member protruding from the corner key, wherein the second capillary break member is positioned between the first joint surface and the second joint surface at a second location when the first frame member and the second frame member are assembled with the corner key to form the corner joint, and wherein the second location is different than the first location.

In one or more embodiments of the corner joints described herein, at least one of the first the capillary break member and the second capillary break member comprises a continuous body extending completely across an interface between the first joint surface and the second joint surface.

In one or more embodiments of the corner joints described herein, the first frame member and the second frame member form a glazing channel when assembled to form the corner joint, and wherein the first capillary break member comprises a continuous body extending across completely across an interface between the first joint surface and the second joint surface on a side of the glazing channel. In one or more embodiments, the first capillary break member extends into the glazing channel.

In one or more embodiments of the corner joints described herein, a portion of the first capillary break member extends into a glazing channel formed by the first frame member and the second frame member as assembled to form the corner joint.

In one or more embodiments of the corner joints described herein, the second capillary break member is located in the interface between the first joint surface and the second joint surface along the an outside edge of the corner joint when the corner joint is assembled. In one or more embodiments, the second capillary break member comprises a continuous body extending across completely across the interface between the first joint surface and the second joint surface at the outside edge of the corner joint. In one or more embodiments, the second capillary break member protrudes from the outside edge of the corner joint.

In one or more embodiments of the corner joints described herein, the first joint surface is not directly attached to the second joint surface within the corner joint.

In one or more embodiments of the corner joints described herein, the first capillary break member and the second capillary break member each comprise a compressible member.

In one or more embodiments of the corner joints described herein, the first capillary break member and the second capillary break member each comprise a resiliently compressible member.

In another aspect, one or more embodiments of methods of assembling a corner joint may include: inserting a first leg of a corner key into a first corner end opening of a first frame member; and inserting a second leg of the corner key into a second corner end opening of a second frame member; wherein a first joint surface of the first frame member faces a second joint surface of the second frame member when the first frame member and the second frame member are assembled with the corner key to form the corner joint; wherein a capillary break member is located between the first joint surface and the second joint surface when the first frame member and the second frame member are assembled with the corner key to form the corner joint; and wherein the capillary break member protrudes from the corner key before the first leg of the corner key is inserted into the first corner end opening of the first frame member and before the second leg of the corner key into a second corner end opening of a second frame member.

In one or more embodiments of the methods described herein, the capillary break member comprises a continuous body extending completely across an interface between the first joint surface and the second joint surface.

In one or more embodiments of the methods described herein, the first frame member and the second frame member form a glazing channel when assembled to form the corner joint, and wherein the capillary break member comprises a continuous body extending across completely across an interface between the first joint surface and the second joint surface on a side of the glazing channel. In one or more embodiments, the capillary break member extends into the glazing channel.

In one or more embodiments of the methods described herein, a portion of the capillary break member extends into a glazing channel formed by the first frame member and the second frame member as assembled to form the corner joint.

In one or more embodiments of the methods described herein, the method involves locating the capillary break member in the interface between the first joint surface and the second joint surface along the an outside edge of the corner joint. In one or more embodiments, the capillary break member comprises a continuous body extending across completely across the interface between the first joint surface and the second joint surface at the outside edge of the corner joint. In one or more embodiments, the capillary break member protrudes from the outside edge of the corner joint.

In one or more embodiments of the methods described herein, the first joint surface is not directly attached to the second joint surface within the corner joint.

In one or more embodiments of the methods described herein, the capillary break member comprises a compressible member, and wherein the method comprises compressing the capillary break member between the first and second joint surfaces.

In one or more embodiments of the methods described herein, the capillary break member comprises a resiliently compressible member, and wherein the method comprises compressing the capillary break member between the first and second joint surfaces.

The above summary is not intended to describe each embodiment or every implementation of the corner joints described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

FIG. 1 is depicts one illustrative embodiment of a corner joint as described herein.

FIG. 2 depicts the corner joint of FIG. 1 in an exploded view illustrating the corner key used in connection with the frame members to form the corner joint.

FIG. 2A is an enlarged end view of frame member 20 depicted in FIG. 2.

FIG. 2B is an enlarged end view of frame member 20 as depicted in FIG. 2A along with a partial view of a retaining strip used to form a glazing channel with the frame member and a glazing panel that is located within the glazing channel when assembled.

FIG. 3 is an enlarged view of the corner key inserted into one frame member of a corner joint as described herein.

FIG. 3A is an enlarged partial cross-sectional view of the capillary break member and corner key (in cross-section) taken along line 3A-3A in FIG. 3.

FIG. 3B is an enlarged portion of FIG. 3A depicting the capillary break member 40 and its attachment to the corner key 50 (with both the capillary break member 40 and the corner key 50 in cross-section).

FIG. 3C is an enlarged cross-sectional view taken through the interface formed between the joint surfaces of the frame members depicting compression of a capillary break member within the interface (taken along line 3C-3C in FIG. 3B).

FIG. 4 is a side view of the corner key of FIG. 3 removed from the frame member.

FIG. 5 is a side view of the corner key of FIG. 4 taken from the perspective illustrated by line 5-5 in FIG. 4.

FIG. 6 is an enlarged view of an alternative structure that can be used to retain a capillary break member in a corner key as described herein.

FIG. 7 is an enlarged partial cross-sectional view of an alternative embodiment of a capillary break member located in a corner key as described herein.

FIG. 8 is an enlarged cross-sectional view of a capillary break member separated from a corner key and located within an interface between two frame members as described herein.

FIG. 9 is an exploded view of another illustrative embodiment of a corner joint as described herein.

FIG. 10 is a view of the corner joint of FIG. 9 after assembly.

FIG. 11 is an end view of the frame member 120 taken along line 11-11 in FIG. 10, with the addition of a glazing panel located in the glazing channel.

FIG. 12 is a perspective view of the corner key of FIG. 9 depicting the interior of the corner key.

FIG. 13 is a view of the corner key of FIG. 9 taken from line 13-13 in FIG. 9.

FIG. 14 is a left-side view of the corner key as depicted in FIG. 13.

FIG. 15 is a view of a frame incorporating one or more corner joints as described herein.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

Each of the corner joints described herein includes a pair of frame members that meet at a corner in which the frame members are typically, but not necessarily arranged to form a right angle. Within the corner joint, both of the frame members preferably include a mitered joint surface that, in a corner joint formed at a right angle, is typically at a 45 degree angle to the longitudinal axis of the frame member. Although the corner joints described herein may be formed at right angles with mitered joint surfaces at a 45 degree angle, in some embodiments, the corner joints described herein may be used to connect frame members that do not meet at a right angle and the angle of the mitered joint surfaces relative to the longitudinal axes of the frame members may be adjusted accordingly (although it may be preferred that, in some embodiments, the mitered joint surfaces bisect the angle formed by the frame members in the assembled corner joint).

The corner keys of the corner joints described herein include one or more capillary break members protruding from the corner key. The capillary break members are located in the interface between the first joint surface and the second joint surface when the first frame member and the second frame member are assembled with the corner key to form the corner joint. By providing one or more capillary break members in the interface, movement of water from the exterior side to the interior side of the corner joint can be interrupted.

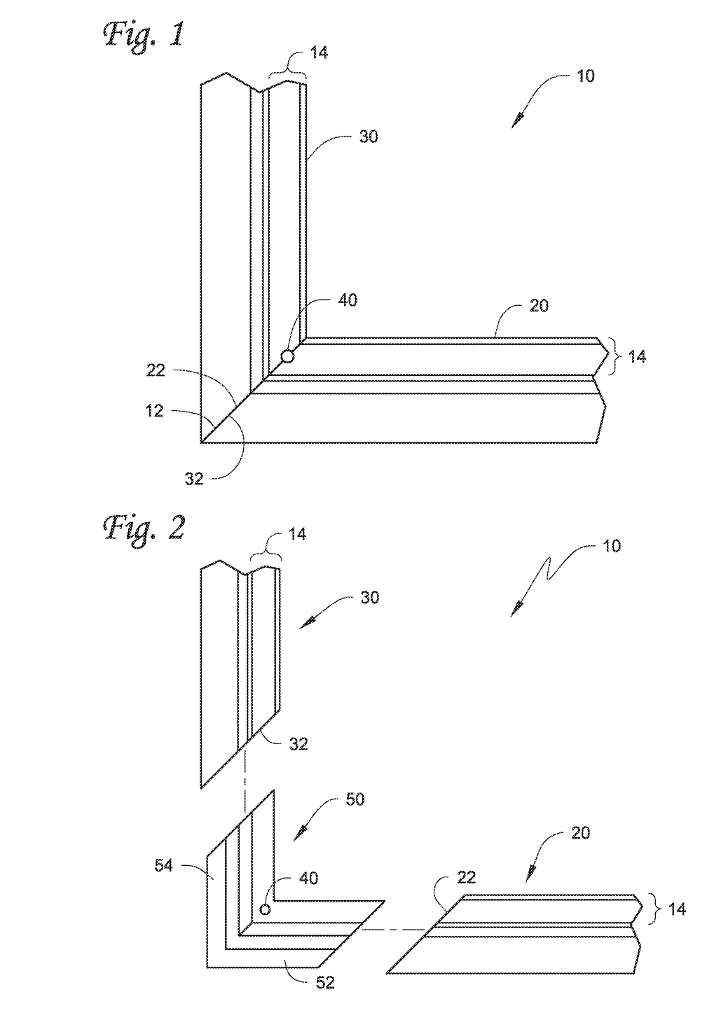

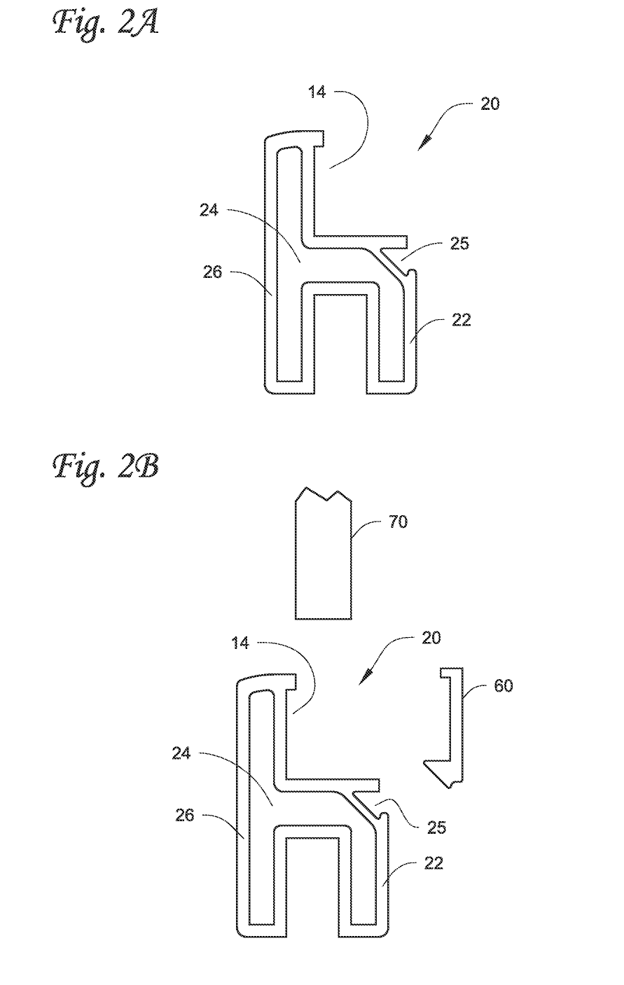

One illustrative embodiment of a corner joint as described herein is depicted in FIGS. 1-2. The corner joint 10 includes a first frame member 20, a second frame member 30 and a corner key 50 that fits within the ends of each of the first frame member 20 and the second frame member 30.

The attachment of the frame members 20 and 30 to form the corner joints described herein may be achieved using the corner key 50, in combination with any suitable joining technique or combination of joining techniques. Examples of some potentially suitable joining techniques that may be used in combination with the corner keys may include threaded fasteners (e.g., screws, etc.), pins, rivets, adhesives, welding (thermal and/or chemical), etc. The corner keys as described herein also serve as a vehicle for placing the capillary break members in selected locations of the interface between the frame members.

The illustrative corner joint 10 depicted in FIGS. 1-2 is the corner joint of a window sash for, e.g., a vertically sliding window. As discussed herein, however, the corner joint constructions described herein can be used in any structure in which two frame members are to be connected at a corner where a capillary break is desired, e.g., other window sashes, doors, window frames, door frames, etc.

The frame members used in the corner joints described herein may be manufactured by a variety of processes. It may, however, be preferred that the frame members be manufactured of an extruded material which may include fibers and a polymer, pultruded materials, etc. Examples of some potentially suitable materials for frame members that may be used to construct corner joints as described herein may include those described in, e.g., U.S. Pat. No. 5,585,155 (Heikkila et al.); U.S. Pat. No. 6,106,944 (Heikkila et al.); U.S. Pat. No. 6,210,792 Seethamraju et al.); U.S. Pat. No. 6,260,251 (Guhl); U.S. Pat. No. 6,280,667 (Koenig et al.); U.S. Pat. No. 6,342,172 (Finley); etc.

Referring generally to FIGS. 1-3, the first frame member 20 includes a first corner end that faces the horizontal leg 52 of the corner key 50. The first corner end 22 may include a first corner end opening into which the leg 52 of corner key 50 is inserted. The corner end opening of the first frame member 20 is, in the depicted embodiment preferably provided by the open or hollow volume formed within first frame member 20. The hollow construction of the frame member 20 is seen in the end view of frame member depicted in FIG. 2A. The frame member 20 defines an interior volume 24 into which the leg 52 of the corner key 50 is inserted.

Although the end of the frame member 20 may preferably be hollow such that it forms an interior volume 24 capable of receiving the leg 52 of the corner key 50, the remainder of the frame member 20 may or may not be hollow. For example, in some embodiments, the volume 24 past the depth to which the leg 52 of the corner key 50 is inserted may be solid and/or may be filled one or more materials such as foam, etc.

Other features depicted in FIG. 2B are a glazing bead 60 that, when attached to the frame member 20, forms a glazing channel 14 into which the edge of a glazing panel 70 is inserted. A glazing channel is also formed in the second frame member 30 in a similar manner. When assembled to form a completed frame, the frame members forming the corner joints described herein may preferably define a glazing channel that retains the edges of the glazing panel about the perimeter of the glazing channel. Glazing panel 70 may be a single pane of transparent and/or translucent material or it may include multiple panes or layers. For example, some embodiments of glazing panels may include laminated glass, dual or triple pane insulated glazing units, etc.

Leakage of water through the interface between the glazing panel 70 and the glazing channel 14 may be addressed by, e.g., one or more seals located between the glazing panel 70 and the glazing channel 14. The seals may be formed by structural members inserted between the glazing panel 70 and the sides of the glazing channel 14 and/or by a flowable sealant deposited in the selected locations. The specific details regarding structural members such as frame members 20 and 30, glazing bead 60, seals, etc. that are used to retain and seal structures such as, e.g., glazing panel 70 in a glazing channel 14 are known and will not be further described herein.

Also depicted in FIG. 2A is the joint surface 26 of the frame member 20. The joint surface 26 is typically formed when the frame member 20 is trimmed, cut, etc. to the selected length needed for the frame in which it is used. Although not depicted, the second frame member 30 also includes a similar joint surface at its corner end 32. The two joint surfaces of the frame members 20 and 30 meet to form an interface 12 (see FIG. 1). The joint surfaces need not be directly attached to each other within the corner joint 10. Rather, the corner joint 10 is connected using the corner key 50 and, typically, adhesive material that is delivered into the corner joint 10 using known techniques (although other joining techniques as described herein may be used with the corner keys in addition to or in place of adhesive material).

Although the penetration of water through the glazing channel 14 may be sufficiently impeded by seals provided between the glazing panel 70 and the glazing channel 14, leakage of water from the exterior side of the corner joint to the interior side of the corner joint can still potentially occur through the interface 12 between the joint surfaces of the frame members 20 and 30 in corner joints such as corner joint 10 in which the joint surfaces are not directly attached to each other along the interface 12. In some corner joints similar to the corner joint 10, a thin film of water may be present in the exterior portion of the interface 12. Capillary action may cause the film of water in the interface 12 to advance to the interior side of the corner joint.

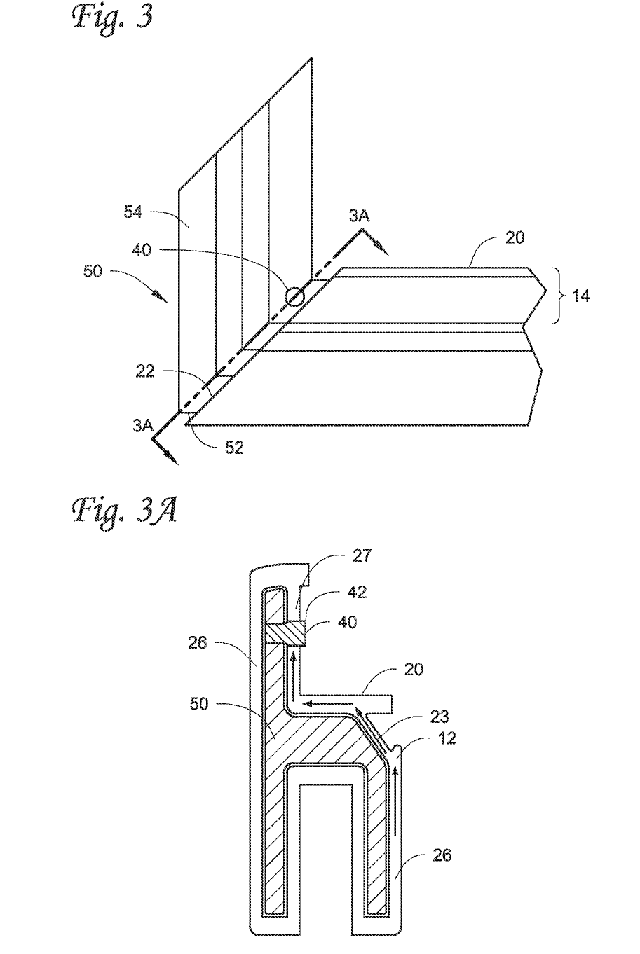

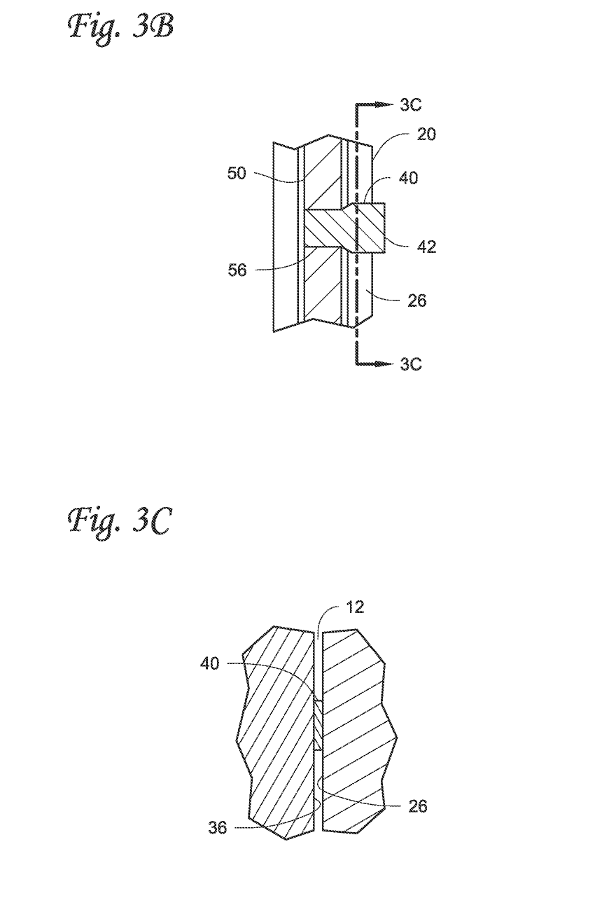

The corner joints described herein, however, include one or more capillary break members that are located between the joint surfaces in the interface 12 to block movement of water along the interface 12. One embodiment of a capillary break member 40 is seen in FIGS. 1, 2, and 3A-3C. The capillary break member 40 is seen protruding from the interface 12 in FIG. 1 (because glazing bead 60 from FIG. 2A is not present in FIG. 1). As depicted in FIG. 3A, the capillary break member 40 is attached to and protrudes from the corner key 50 such that it is positioned in the interface 12 between the joint surfaces of the frame members 20 and 30 when the corner joint 10 is assembled. As a result, water that may enter interface 12 on the exterior side of the frame member 20 and move through capillary action in the direction shown by arrows 23 is blocked by capillary break member 40 from passing into the interior portion 27 of the interface 12.

Referring to FIG. 3, the corner key 50 is depicted with leg 52 partially inserted into the corner key end opening such that the leg 52 resides within the volume 24 in the frame member 20. FIG. 3 is also useful for depicting the location of the capillary break member 40 relative to the end 22 of frame member 20. The frame member 20 is not, in FIG. 3, fully seated onto the leg 52 of corner key 50. It may be preferred that end 22 (i.e., the joint surface 26) contact or abut the capillary break member 40 when the leg 52 of corner key 50 is fully seated in the end of frame member 20.

Referring to FIG. 3A,which is a partial cross-sectional view of FIG. 3 taken along line 3A-3A, various features of the capillary break member 40 with respect to the corner key 50 and the frame number 20 can be described. In particular, the view depicted in FIG. 3A shows that the capillary break member 40 preferably extends or protrudes from the corner key 50 such that the free end 42 of the capillary break member 40 extends into the volume that would form the glazing channel 14 relative to the frame member 20 and its joint surface 26. As a result, the capillary break member 40 is visible in, for example, FIG. 1 when the corner joint 10 is fully assembled and no glazing panel is located therein.

In particular, it may be preferred that, in some embodiments, the capillary break member 40 be in the form of a continuous body that extends outwardly or protrudes from the corner key 50 and has a length that is sufficient such that the capillary break member 40 can extend completely across interface 12 between the first joint surface 26 and the second joint surface 36 of the frame members 20 and 30, respectively. The capillary break member 40 may preferably extend completely across the interface 12 between the joint surfaces of the frame members 20 and 30 in a manner that results in at least the end 42 of the capillary break member 40 extending into the glazing channel 14. The result of a capillary break member 40 that extends into the glazing channel 14 is depicted in FIG. 1 where the end of the capillary break member 40 is seen within the glazing channel 14 formed by the frame members 20 and 30.

Another feature depicted in FIG. 3B is the connection between the capillary break number 40 and the corner key 50. In the depicted embodiment, the capillary break member 40 is located within an opening 56 formed in the corner key 50. In those embodiments in which the capillary break member 40 is constructed of compressible materials as described herein, the size of the opening 56 may preferably have a cross-sectional area that is smaller than the cross-sectional area of the capillary break member 40 such that the capillary break member 40 must be compressed to fit within the opening 56 in the corner key 50.

In some embodiments, the frictional forces generated by compression of the capillary break member 40 within the opening 56 may be sufficient to hold the capillary break member 40 in the opening 56 alone. In other embodiments, however, it may be desirable to use one or more techniques in addition to or in place of compression to retain the capillary break member in attachment with the corner key 50 during assembly of the corner joints described herein. Examples of other potentially useful techniques to retain the capillary break member 40 in position with respect to the corner key 50 are the use of adhesives, molding (e.g., over molding, injection molding, insert molding, two-shot molding etc. that may occur as, e.g., a apart of the process of manufacturing the corner key), thermal or chemical welding, etc.

FIG. 3C is an enlarged partial cross-sectional view of the interface 12 at which the joint surface 26 of frame member 20 meets the joint surface 36 of frame member 30, with the capillary break member 40 located between the joint surfaces 26 and 36 within the interface 12. As seen in FIG. 3C, the joint surfaces 26 and 36 of the respective frame members 20 and 30 are positioned on opposite sides of the compressed capillary break member 40.

When assembled into a corner joint, the capillary break member 40 is compressed between the joint surfaces 26 and 36 with that compression being depicted in FIG. 3C. As a result, the capillary break member 40 is preferably constructed of materials that are compressible such that the width of the capillary break member 40 before assembly of the corner key 50 in joint 10 is greater than the compressed width of the capillary break member 40 when located within the interface 12 in an assembled corner joint 10. Any suitably compressible material could be used for the capillary break member 40. By “compressible” it is meant that the capillary break member 40 can be compressed to a dimension that is small enough to allow a suitable interface 12 formed in the visible portions of the corner joint 10.

In some embodiments, the compressible materials used for the capillary break member 40 may also be resilient in addition to compressible. As used herein, “resiliently compressible” means that the materials used for the capillary break member will exhibit some elastic recovery after their compression within, e.g., the interface 12 of a corner joint 10. That elastic recovery may, for example, be described as allowing for a recovery to a post-compression dimension (e.g., width) that is at least 90% of an original dimension within a period of five (5) minutes or less after having been compressed from the original dimension to a compressed dimension that is no more than 50% of the original dimension within an interface in a corner joint for a period of one (1) minute. It may be preferred that the materials used for the capillary break members retain their resiliently compressible characteristics over time, after repeated thermal and mechanical cycling as the joint in which they are located expands and contracts due to changes in temperature.

Examples of some potentially suitable resiliently compressible materials that may be used for the capillary break members include open cell foams, closed cell foams, rubbers, elastomers, etc. One example of a potentially suitable material for the capillary break member is a closed cell silicone foam manufactured by Rogers Corporation and sold as a silicone sponge material under the designation HT-800.

Although the capillary break members depicted in the figures are in the shape of circular cylinders, it should be understood that the capillary break members used in the corner joints described herein may be provided in any suitable shape, e.g., non-circular cylinders, sheets, etc.

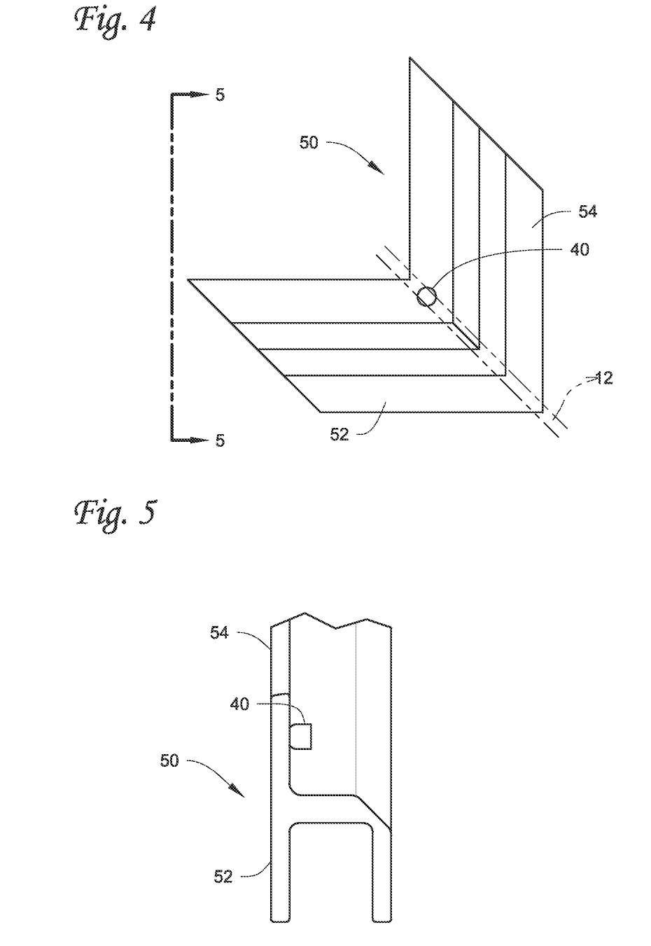

Referring to FIGS. 4-5, one illustrative embodiment of a corner key 50 as used in connection with the corner joints described herein is depicted. As discussed herein, the corner key 50 includes legs 52 and 54 that are preferably sized and shaped for insertion into the open ends of frame members to form a corner joint. Typically, the legs 52 and 54 of the corner key 50 are, therefore, shaped to be fit within the openings at the ends of frame members 20 and 30 into which the legs of the corner key are inserted when the corner joint is assembled. The capillary break member 40 preferably protrudes from the corner key 50 such that the capillary break member 40 will be located within the interface (see broken lines 12 in FIG. 4) between the joint surfaces of the frame members 20 and 30 when the corner key is assembled with those frame members as discussed above in connection with, e.g., FIGS. 3 and 3A-3C.

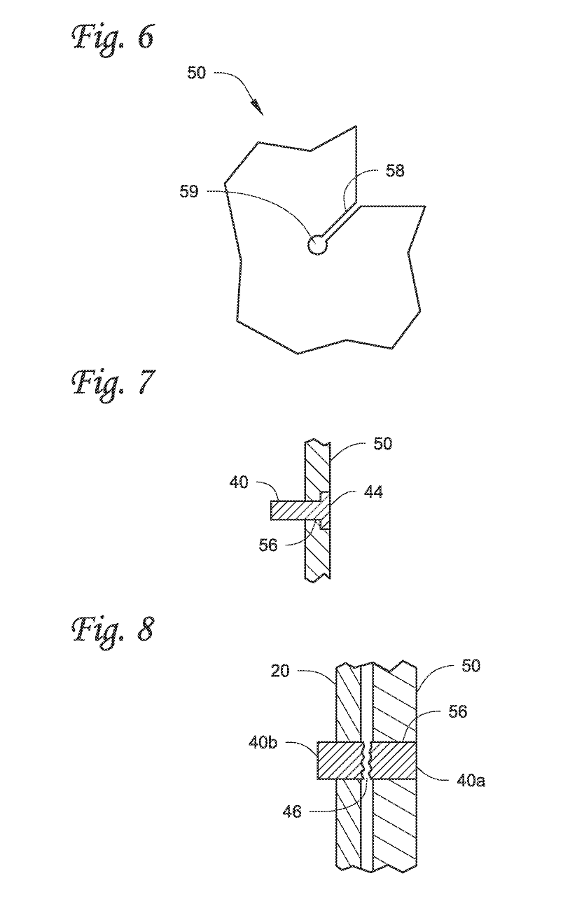

Although the capillary break members described herein may be inserted into an opening formed in the corner key as discussed above in connection with FIG. 3B, alternative arrangements for retaining the capillary break members in a selected location on a corner key may be used. With respect to FIG. 6, the corner key 50 may include a slot 58 such that the capillary break member can be advanced into an opening 59 (which may be enlarged as depicted in FIG. 6 or may simply be located at the terminal end of the slot 58). As discussed above in connection with the retention of capillary break member 40 in FIG. 3B, a variety of one or more other techniques (e.g., adhesives, welding, etc.) may be used to assist in retaining the capillary break member in the opening 59 in addition to or in place of any frictional forces generated between the capillary break member and the opening 59.

FIG. 7 depicts yet another set of optional features that may be useful in retaining a capillary break member 40 in an opening 56 within a corner key 50. In particular, the embodiment depicted in FIG. 7 includes a capillary break member 40 having a base 44 that is widened or enlarged such that advancement of the capillary break member 40 through the opening 56 is restricted or prevented.

It is also contemplated that tools or other apparatus may be used to attach or install capillary break members into or on corner keys. Such tools may include, for example, devices for compressing the capillary break member before inserting it into an opening, as well as vacuum apparatus, welding apparatus, adhesive application apparatus, etc.

Another feature of some embodiments of corner joints described herein is depicted in the enlarged cross-section view of FIG. 8. In particular, the view depicted in FIG. 8 shows a capillary break member that has been separated as a result of the assembly process. As depicted, the capillary break member of FIG. 8 has been separated into first portion 40a which remains attached to the corner key 50 (within, e.g., opening 56) while a second portion 40b is in position within the interface between the joint surface 26 of frame member 20 and an opposing joint surface (not shown). The first portion 40a may, in some embodiments, be separated from the second portion by a gap 46 as depicted, although such a gap is not necessarily present in all embodiments. In other embodiments, no portion of the capillary break member may remain connected to the corner key 50, i.e., the capillary break member may be completely detached from the corner key 50 when the corner joint is fully assembled. Separation of capillary break members as described herein is acceptable so long as the separations do not result in alternative leakage paths that would defeat the function of the capillary break member as described herein.

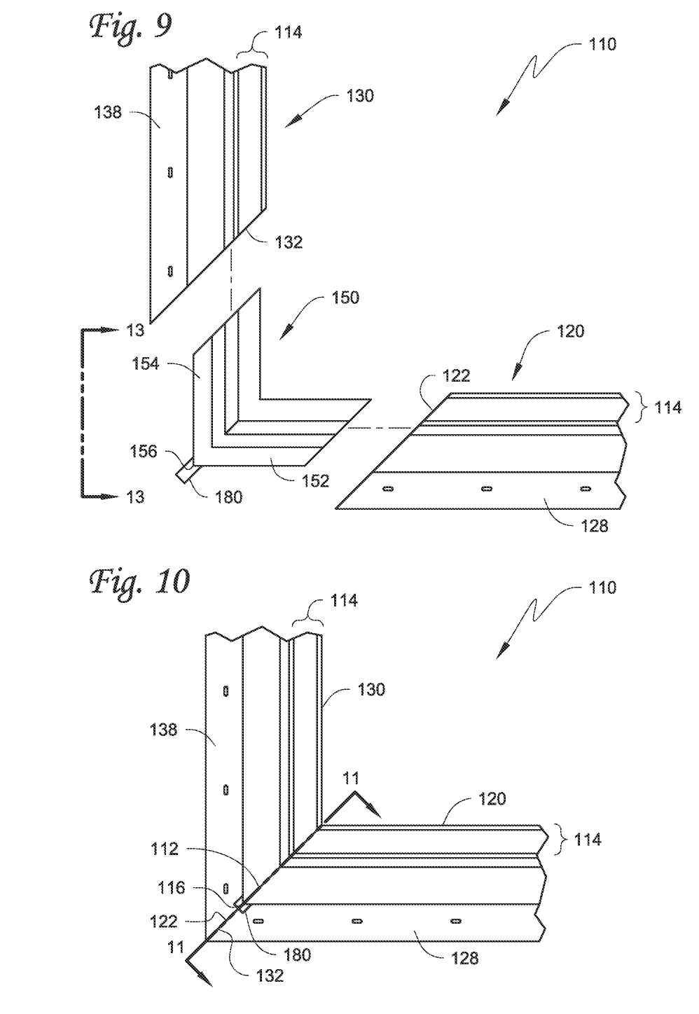

Another embodiment of a corner joint 110 and components thereof is depicted in FIGS. 9-14. Whereas the corner joint 10 depicted and described with reference to FIGS. 1-8 may be adapted for use in, e.g., a sash frame, the corner joint 110 depicted in FIGS. 9-14 may be suited for use in, e.g., a picture window frame. The corner joint 110 includes a first frame member 120, a second frame member 130 and a corner key 150 that fits within the ends of each of the first frame member 120 and the second frame member 130. Because the frame members 120 and 130 are used to form a window frame, they may preferably include nailing flanges 128 and 138, respectively, that can be used to secure the frame within, e.g., an opening.

The attachment of the frame members 120 and 130 to form the corner joint 110 may be achieved using the corner key 150, in combination with any suitable technique or combination of techniques as discussed above with respect to the corner joint 10. Further, the frame members 120 and 130 used in the corner joint 110 may be manufactured by a variety of processes as is also discussed herein.

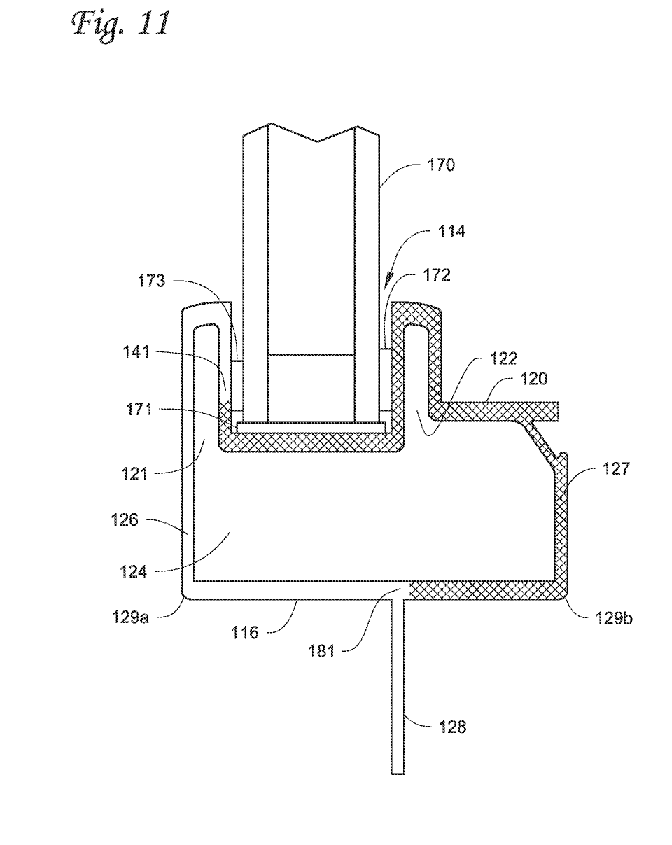

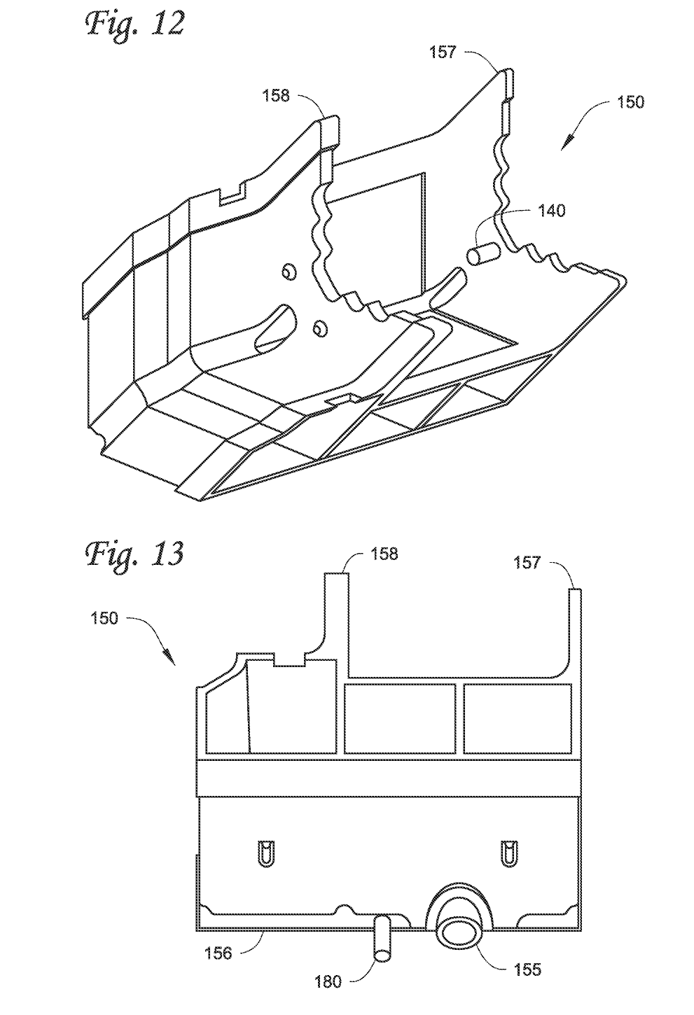

Referring generally to FIGS. 9-11, the first frame member 120 includes a first corner end 122 that faces the horizontal leg 152 of the corner key 150. The first corner end 122 may include a first corner end opening into which the leg 152 of corner key 150 is inserted (in a manner similar to that discussed above in connection corner joint 10). The corner end opening of the first frame member 120 is, in the depicted embodiment preferably provided by the open or hollow volume 124 formed within first frame member 120. The hollow construction of the frame member 120 is depicted in the end view of frame member depicted in FIG. 11. The frame member 120 defines in interior volume 124 into which the leg 152 of the corner key 150 is inserted as a part of the assembly of the corner joint 110. Referring to FIGS. 11 and 12, the slots 121 and 122 may be sized and positioned to receive the fins 157 and 158 on the corner key 150.

Although the end of the frame member 120 may preferably be hollow such that it forms an interior volume 124 capable of receiving the leg 152 of the corner key 150, the remainder of the frame member 120 may or may not be hollow. For example, in some embodiments, the volume 124 past the depth to which the leg 152 of the corner key 150 is inserted may be solid and/or may be filled one or more materials such as foam, etc.

Also depicted in FIG. 11 is the joint surface 126 of the frame member 120. The joint surface 126 is typically formed when the frame member 120 is trimmed, cut, etc. to the selected length needed for the frame in which it is used. Although not depicted, the second frame member 130 also includes a similar joint surface at its corner end 132. The two joint surfaces of the frame members 120 and 130 meet to form an interface 112 (see FIG. 10). The joint surfaces are not directly attached to each other within the corner joint 110. Rather, the corner joint 110 is connected using the corner key 150 and, in some embodiments, adhesive material that is delivered into the corner joint 110 using known techniques (although other joining techniques as described herein may be used with the corner keys in addition to or in place of adhesive material). In the depicted embodiment, the corner key 150 may include an adhesive port 155 through which flowable material may be injected into the corner joint 110 as a part of the assembly process. That port 155 may protrude from the corner joint 110 through an opening 125 (see, e.g., FIG. 11) formed in the joint surface 126 of frame member 120.

Another feature depicted in connection with the corner joint 110 is a glazing channel 114 into which the edge of a glazing panel 170 is inserted (as seen in FIG. 11). A glazing channel 114 is also formed in the second frame member 130 in a similar manner. In the depicted embodiment, the glazing panel 170 may be supported above the bottom of the glazing channel 114 by, e.g., one or more setting blocks 171. Leakage of water through the interface between the glazing panel 170 and the glazing channel 114 may be addressed by, e.g., a seal 172 on an exterior side of the glazing panel 170 and/or a seal 173 on the interior side of the glazing panel 170. The seals 172 and/or 173 may be formed by structural members positioned between the glazing panel 170 and the sides of the glazing channel 114 and/or by a flowable sealant deposited in the selected locations.

Although the penetration of water through the glazing channel 114 may be sufficiently impeded by the seals 172 and/or 173, leakage of water from the exterior side of the corner joint to the interior side of the corner joint can still potentially occur through the interface 112 between the joint surfaces of the frame member 120 and 130 in corner joints such as corner joint 110 in which the joint surfaces are not directly attached to each other along the interface 112.

In some corner joints similar to the corner joint 110, a thin film of water may be present in the exterior portion of the interface 112. The shaded portion 127 of the joint surface 126 (see FIG. 11) is provided to illustrate where the thin film of water may be present in the interface 112.

As discussed herein, capillary action may cause the film of water in the shaded area to advance to the interior side of the corner joint. The corner joints described herein, however, include one or more capillary break members that are located between the joint surfaces in the interface 112 to block movement of water along the interface 112. One embodiment of a capillary break member 40 located within the glazing channel 14 to block capillary movement through the interface in a glazing channel depicted in FIGS. 1-3. Referring to FIG. 12, a similar capillary break member 140 could protrude from the corner key 150 such that, when assembled to form the corner joint 110, the capillary break member 140 is positioned at location 141 along the joint surface 126 as depicted in FIG. 11.

Although it may be useful to provide a capillary break member in the glazing channel of corner joints as described herein, one or more capillary break members may be provided in at least one other location of the interface between the frame members in corner joints as described herein.

The illustrative embodiment of corner joint 110 depicted in FIGS. 9-14 includes, for example, a capillary break member that is positioned along an outside edge of the corner joint. For example, a capillary break member 180 may protrude from the interface 112 along the outside edge 116 of the corner joint 110 (see, e.g., FIG. 10). As depicted in FIGS. 9 and 13-14, the capillary break member 180 may preferably be attached to and protrude from the outside edge 156 of the corner key 150 such that the capillary break member 180 is positioned in the interface 112 between the joint surfaces of the frame members 120 and 130 where it can, in some embodiments, protrude from the outside edge 116 of the corner joint 110.

Referring to FIG. 11, the position of the capillary break member 180 may be selected to impede progress of water through the interface 112 past the nailing flange 128. For example, the capillary break member 180 may be provided at location 181 in FIG. 11 such that water in the interface 112 remains outside of the nailing flange 128. In some embodiments, capillary members positioned along the outside edge of a corner joint that includes a nailing flange may be aligned with the nailing flange (such that the capillary break member straddles the nailing flange) and/or may be located closer to the nailing flange 128 than to either the interior end 129a or the exterior end 129b of the outside edge 116.

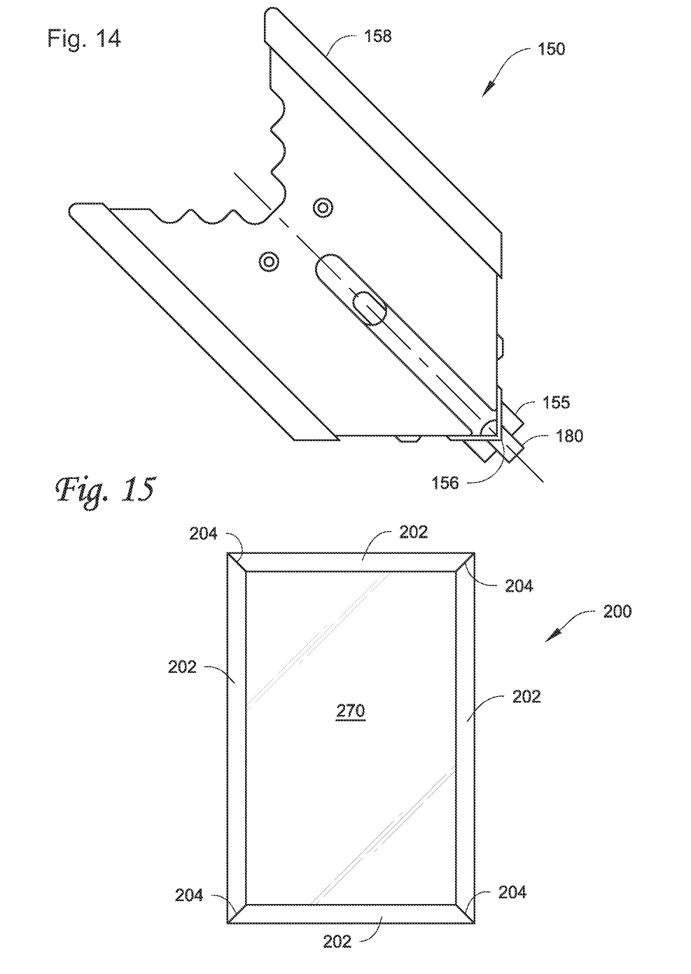

Referring to FIGS. 13 and 14, the capillary break member 180 may preferably protrude from a corner edge 156 of the corner key 150 such that it is located at position 181 of FIG. 11. The capillary break member 180 may be attached to the corner key 150 by any of the techniques described above in connection with capillary break member 40. As seen in FIGS. 12 and 13, the corner key 150 may also include fins 157 and 158 that fit within corresponding cavities 121 and 122 (see, e.g., FIG. 11) in the frame members 120 and 130 as is described herein.

It should be noted that the corner joint 110 depicted in FIGS. 9-10 and the associated end of frame member 120 In FIG. 11 are views of a left-hand corner joint, whereas the corner key depicted in FIGS. 12-14 is a corner key for a right-hand corner. As a result, the corner key depicted in FIGS. 12-14 is a mirror image of the corner key that would be used in a left-hand corner joint, although the features are general construction are the same and these differences will be readily appreciated by one of ordinary skill in the art.

It may be preferred that the capillary break member 180 be compressed within the interface as discussed above in connection with capillary break member 40. It may further be preferred that the capillary break member 180 extend across the entire width of the interface 112 from the interior edges of the joint surfaces to the exterior edges of the joint surfaces. In some embodiments, the capillary break member 180 may protrude from the assembled corner joint 110 (as depicted in, e.g., FIG. 10).

FIG. 14 depicts one illustrative embodiment of a frame 200 that includes frame members 202. The frame members meet at corner joints 204 and a glazing panel 270 is located within the frame 200. One or more of the corner joints 204 in the frame 200 may include one or more capillary break members as described herein.

The complete disclosure of any patents, patent documents, and publications identified herein are incorporated by reference in their entirety as if each were individually incorporated. To the extent there is a conflict or discrepancy between this document and the disclosure in any such incorporated document, this document will control.

Illustrative embodiments are discussed and reference has been made to possible variations. These and other variations and modifications in the invention will be apparent to those skilled in the art without departing from the scope of the invention, and it should be understood that this invention is not limited to the illustrative embodiments set forth herein and, further, that this invention may be suitably practiced in the absence of any element not specifically disclosed as necessary herein. Accordingly, the invention is to be limited only by the claims provided below and equivalents thereof.

What is claimed is:

1. A corner joint comprising:
a first frame member comprising a first corner end, wherein the first corner end comprises a first joint surface and a first corner end opening;
a second frame member comprising a second corner end, wherein the second corner end comprises a second joint surface and a second corner end opening, wherein the second joint surface faces the first joint surface when the second frame member and the first frame member are assembled to form a corner;
a corner key comprising a first leg and a second leg, wherein the first leg is located in the first corner end opening and the second leg is located in the second corner end opening when the first frame member and the second frame member are assembled with the corner key to form the corner joint; and
a capillary break member protruding from the corner key, wherein the capillary break member is located between the first joint surface and the second joint surface when the first frame member and the second frame member are assembled with the corner key to form the corner joint.

2. A corner joint according to claim 1, wherein the capillary break member comprises a continuous body extending completely across an interface between the first joint surface and the second joint surface.

3. A corner joint according to claim 1, wherein the first frame member and the second frame member form a glazing channel when assembled to form the corner joint, and wherein the capillary break member comprises a continuous body extending across completely across an interface between the first joint surface and the second joint surface on a side of the glazing channel.

4. A corner joint according to claim 3, wherein the capillary break member extends into the glazing channel.

5. A corner joint according to claim 1, wherein a portion of the capillary break member extends into a glazing channel formed by the first frame member and the second frame member as assembled to form the corner joint.

6. A corner joint according to claim 1, wherein, when assembled to form the corner joint, the capillary break member is located in the interface between the first joint surface and the second joint surface along the an outside edge of the corner joint.

7. A corner joint according to claim 6, wherein the capillary break member comprises a continuous body extending across completely across the interface between the first joint surface and the second joint surface at the outside edge of the corner joint.

8. A corner joint according to claim 6, wherein the capillary break member protrudes from the outside edge of the corner joint.

9. A corner joint according to claim 1, wherein the first joint surface is not directly attached to the second joint surface within the corner joint.

10. A corner joint according to claim 1, wherein the capillary break member comprises a compressible member.

11. A corner joint according to claim 1, wherein the capillary break member comprises a resiliently compressible member.

12. A corner joint according to claim 1, wherein the capillary break member is insert molded with the corner key.

13. A corner joint according to claim 1, wherein a portion of the capillary break member is located in an opening in the corner key.

14. A corner joint according to claim 13, wherein the opening comprises a slot that comprises an external opening located along an edge of the corner key.

15. A corner joint comprising:
a first frame member comprising a first corner end, wherein the first corner end comprises a first joint surface and a first corner end opening;
a second frame member comprising a second corner end, wherein the second corner end comprises a second joint surface and a second corner end opening, wherein the second joint surface faces the first joint surface when the second frame member and the first frame member are assembled to form a corner;
a corner key comprising a first leg and a second leg, wherein the first leg is located in the first corner end opening and the second leg is located in the second corner end opening when the first frame member and the second frame member are assembled with the corner key to form the corner joint;
a first capillary break member protruding from the corner key, wherein the first capillary break member is positioned between the first joint surface and the second joint surface at a first location when the first frame member and the second frame member are assembled with the corner key to form the corner joint; and
a second capillary break member protruding from the corner key, wherein the second capillary break member is positioned between the first joint surface and the second joint surface at a second location when the first frame member and the second frame member are assembled with the corner key to form the corner joint, and wherein the second location is different than the first location.

16. A corner joint according to claim 15, wherein at least one of the first the capillary break member and the second capillary break member comprises a continuous body extending completely across an interface between the first joint surface and the second joint surface.

17. A corner joint according to claim 15, wherein the first frame member and the second frame member form a glazing channel when assembled to form the corner joint, and wherein the first capillary break member comprises a continuous body extending across completely across an interface between the first joint surface and the second joint surface on a side of the glazing channel.

18. A corner joint according to claim 17, wherein the first capillary break member extends into the glazing channel.

19. A corner joint according to claim 15, wherein a portion of the first capillary break member extends into a glazing channel formed by the first frame member and the second frame member as assembled to form the corner joint.

20. A corner joint according to claim 15, wherein, when assembled to form the corner joint, the second capillary break member is located in the interface between the first joint surface and the second joint surface along the an outside edge of the corner joint.

21. A corner joint according to claim 20, wherein the second capillary break member comprises a continuous body extending across completely across the interface between the first joint surface and the second joint surface at the outside edge of the corner joint.

22. A corner joint according to claim 20, wherein the second capillary break member protrudes from the outside edge of the corner joint.

23. A corner joint according to claim 15, wherein the first joint surface is not directly attached to the second joint surface within the corner joint.

24. A corner joint according to claim 15, wherein the first capillary break member and the second capillary break member each comprise a compressible member.

25. A corner joint according to claim 15, wherein the first capillary break member and the second capillary break member each comprise a resiliently compressible member.

26. A method of assembling a corner joint, wherein the method comprises:
inserting a first leg of a corner key into a first corner end opening of a first frame member; and
inserting a second leg of the corner key into a second corner end opening of a second frame member;
wherein a first joint surface of the first frame member faces a second joint surface of the second frame member when the first frame member and the second frame member are assembled with the corner key to form the corner joint;
wherein a capillary break member is located between the first joint surface and the second joint surface when the first frame member and the second frame member are assembled with the corner key to form the corner joint;
and wherein the capillary break member protrudes from the corner key before the first leg of the corner key is inserted into the first corner end opening of the first frame member and before the second leg of the corner key into a second corner end opening of a second frame member.

27. A method according to claim 26, wherein the capillary break member comprises a continuous body extending completely across an interface between the first joint surface and the second joint surface.

28. A method according to claim 26, wherein the first frame member and the second frame member form a glazing channel when assembled to form the corner joint, and wherein the capillary break member comprises a continuous body extending across completely across an interface between the first joint surface and the second joint surface on a side of the glazing channel.

29. A method according to claim 28, wherein the capillary break member extends into the glazing channel.

30. A method according to claim 26, wherein a portion of the capillary break member extends into a glazing channel formed by the first frame member and the second frame member as assembled to form the corner joint.

31. A method according to claim 26, wherein, when assembled to form the corner joint, the capillary break member is located in the interface between the first joint surface and the second joint surface along the an outside edge of the corner joint.

32. A method according to claim 31, wherein the capillary break member comprises a continuous body extending across completely across the interface between the first joint surface and the second joint surface at the outside edge of the corner joint.

33. A method according to claim 31, wherein the capillary break member protrudes from the outside edge of the corner joint.

34. A method according to claim 26, wherein the first joint surface is not directly attached to the second joint surface within the corner joint.

35. A method according to claim 26, wherein the capillary break member comprises a compressible member, and wherein the method comprises compressing the capillary break member between the first and second joint surfaces.

36. A method according to claim 26, wherein the capillary break member comprises a resiliently compressible member, and wherein the method comprises compressing the capillary break member between the first and second joint surfaces.
